(19) United States
(12) Patent Application Publication
(10) Pub. No.: US 2025/0121281 A1
(43) Pub. Date: Apr. 17, 2025

(54) INTERACTIVE GAME ROOM WITH INTEGRATED PHOTOBOOTH AND AUTO-REFILLABLE EJECTION DEVICE

(71) Applicant: Alexander B. Patterson, Brooklyn, NY (US)

(72) Inventor: Alexander B. Patterson, Brooklyn, NY (US)

(21) Appl. No.: 18/912,504

(22) Filed: Oct. 10, 2024

Related U.S. Application Data
(60) Provisional application No. 63/543,799, filed on Oct. 12, 2023.
(60) Provisional application No. 63/543,870, filed on Oct. 12, 2023.

(51) Int. Cl. A63F 13/28; A63F 13/655

(52) U.S. Cl. CPC A63F 13/28; A63F 13/655

(57) ABSTRACT

Embodiments described herein offer a unique and immersive gaming experience that combines physical gameplay with digital enhancements. The systems and methods may use a series of auto-refillable ejection devices, configured to expel various materials like foam or paint onto players, providing a dynamic and engaging environment. These devices could be controlled by an ejection logic that integrates with game data, device control data, photobooth data, and other potential data types to ensure precise timing and interaction during gameplay. Players are immersed in the game, with moments captured by multiple cameras of an integrated photobooth. The photobooth system could capture real-time images and videos, such as a “bomb explosion” of the ejection devices being engaged, which can be processed, stored, and shared through personalized links or social media platforms. The combination of interactive game mechanics, synchronized control, and shareable media content enhances player engagement, offering a memorable and replayable gaming experience.

### PRIORITY

This application claims the benefit of and priority to U.S. Provisional Application, entitled “Game Bomb Room With Integrated Photobooth,” filed on Oct. 12, 2023 and having application Ser. No. 63/543,799, and U.S. Provisional Application entitled “Auto-Refillable Liquid Ejection Device”, filed Oct. 12, 2023 and having application Ser. No. 63/543,870 the entirety of said application being incorporated herein by reference.

### FIELD

The present disclosure relates to interactive gaming. More particularly, the present disclosure relates to a game room with an ejection device and photobooth capability for use with an interactive game.

### BACKGROUND

Previous approaches to game rooms have typically included various forms of entertainment equipment such as arcade machines, billiards tables, and video game consoles. These game rooms often provide a space for individuals to engage in recreational activities and socialize with others. However, these conventional game rooms have not incorporated interactive elements that combine physical and digital experiences to enhance the overall gaming experience.

Previous interactive game rooms have traditionally provided entertainment through physical equipment like arcade machines, billiard tables, or video game consoles. While these traditional setups allowed for recreational activities and socialization, they lacked the integration of interactive elements that bridge physical and digital experiences. Recently, attempts have been made to incorporate motion-sensing technologies that allow players to control games through body movements. While these have added a layer of engagement, they haven't fully explored the potential of combining physical and digital interactions within a game room environment. Additionally, photo booths were sometimes included for capturing moments, but previous iterations often failed to adequately protect the camera equipment from environmental hazards or tampering.

Similarly, the incorporation of photo booths in these spaces sought to enhance player experiences by allowing users to capture and share moments online. However, one issue is that they often rely on static timers that can miss a lot of the action occurring. Another issue with traditional photo booths was their vulnerability; cameras and associated equipment were prone to damage or interference, especially in an active game room setting. Although there were efforts to enclose the equipment and provide safety measures, these systems often failed to address the dynamic nature of modern interactive game rooms where movement and physical interactions occur frequently.

On another front, previous ejection devices used in interactive settings were generally limited in functionality and adaptability. These systems typically relied on a single canister of material and a single ejection orifice, which restricted their flexibility. Though some attempts were made to increase the rate of ejection by adding multiple orifices, these setups often required separate canisters and pumps, resulting in a more complex and expensive system. Furthermore, the coordination between these multiple systems proved to be a significant challenge, as synchronizing the ejection from multiple locations became difficult to manage without increasing costs and system complexity.

Attempts to enhance these ejection devices included using multiple pumps to improve efficiency and control, but this approach was still confined to systems with a single ejection orifice. The real challenge arose when trying to coordinate multiple orifices and canisters without causing delays or inefficiencies in the ejection process. Although these developments improved some aspects of the system, they failed to offer a truly comprehensive solution that could handle the demands of a dynamic, interactive environment where physical gameplay and seamless ejection processes were critical.

### SUMMARY OF THE DISCLOSURE

Systems and methods for a game room with an ejection device and photobooth capability in accordance with embodiments of the disclosure are described herein. In some embodiments, an ejection device, including: a plurality of ejection orifices; at least one canister of ejection material connected to the plurality of orifices; a series of pumps to: generate pressure for ejection of the ejection material; and provide for moving ejection material from the at least one canister to the plurality of orifices; and a controller to coordinate the series of pumps and ejection of the ejection material.

In some embodiments, an ejection device, wherein the ejection orifices are associated with a series of ejection tubes.

In some embodiments, an ejection device, wherein the ejection tubes are disposed with an ejection orifice at a first end and a conduit connector on the second end.

In some embodiments, an ejection device, wherein the conduit is a flexible pipe.

In some embodiments, an ejection device, wherein the flexible pipe is configured to be disposed between the second end of the ejection tube and to one or more of the at least one canister.

In some embodiments, an ejection device, wherein the canisters are filled with a liquid ejection substance.

In some embodiments, an ejection device, wherein the liquid ejection substance is a paint-based substance.

In some embodiments, an ejection device, wherein the ejection device includes two or more canisters.

In some embodiments, an ejection device, wherein each of the ejection tubes are associated with a single corresponding canister.

In some embodiments, an ejection device, wherein each of the corresponding canisters include a unique color of the paint-based substance.

In some embodiments, an ejection device, wherein each of the corresponding canisters is associated with two or more ejection tubes.

In some embodiments, an ejection device, wherein the liquid ejection substance is a foam-based substance.

In some embodiments, an ejection device, wherein the liquid ejection substance is a slime-based substance.

In some embodiments, an ejection device, wherein the foam-based substance is a uniform color.

In some embodiments, an ejection device, wherein the foam-based substance includes two or more colors.

In some embodiments, an ejection device, wherein the pressure generated for the ejection material is controlled by the controller.

In some embodiments, an ejection device, wherein the controller is in communication with a game logic.

In some embodiments, an ejection device, wherein the pressure is generated based on at least one current game state associated with the game logic.

In some embodiments, an ejection device, wherein ejection of the ejection material is based on a current game state associated with the game logic.

In some embodiments, an ejection device, wherein the current game state is associated with a countdown timer.

In some embodiments, an ejection device, wherein the current game state is associated with a game ending.

In some embodiments, an ejection device, including: a plurality of ejection orifices; at least one canister of ejection material connected to the plurality of orifices; a series of pumps to: generate pressure for ejection of the ejection material; and provide for moving ejection material from the at least one canister to the plurality of orifices; and a controller to coordinate the series of pumps and ejection of the ejection material.

In some embodiments, an ejection device, wherein the ejection orifices are associated with a series of ejection tubes.

In some embodiments, an ejection device, wherein the ejection tubes are disposed with an ejection orifice at a first end and a conduit connector on the second end.

In some embodiments, an ejection device, wherein the conduit is a flexible pipe.

In some embodiments, an ejection device, wherein the flexible pipe is configured to be disposed between the second end of the ejection tube and to one or more of the at least one canister.

In some embodiments, an ejection device, wherein the canisters are filled with a liquid ejection substance.

In some embodiments, an ejection device, wherein the liquid ejection substance is a paint-based substance.

In some embodiments, an ejection device, wherein the ejection device includes two or more canisters.

In some embodiments, an ejection device, wherein each of the ejection tubes are associated with a single corresponding canister.

In some embodiments, an ejection device, wherein each of the corresponding canisters include a unique color of the paint-based substance.

In some embodiments, an ejection device, wherein each of the corresponding canisters is associated with two or more ejection tubes.

In some embodiments, an ejection device, wherein the liquid ejection substance is a foam-based substance.

In some embodiments, an ejection device, wherein the foam-based substance is a uniform color.

In some embodiments, an ejection device, wherein the foam-based substance includes two or more colors.

In some embodiments, an ejection device, wherein the pressure generated for the ejection material is controlled by the controller.

In some embodiments, an ejection device, wherein the controller is in communication with a game logic.

In some embodiments, an ejection device, wherein the pressure is generated based on at least one current game state associated with the game logic.

In some embodiments, an ejection device, wherein ejection of the ejection material is based on a current game state associated with the game logic.

In some embodiments, an ejection device, wherein the current game state is associated with a countdown timer.

In some embodiments, an ejection device, wherein the current game state is associated with a game ending.

In some embodiments, a game room, including: an ejection device including: a plurality of ejection orifices; at least one canister of ejection material connected to the plurality of orifices; a series of pumps to: generate pressure for ejection of the ejection material; and provide for moving ejection material from the at least one canister to the plurality of orifices; and a controller to coordinate the series of pumps and ejection of the ejection material; and a photobooth device, including: a camera, a communication interface commutatively coupled with the camera; and a safety enclosure configured to shield the camera from the surrounding environment.

In some embodiments, a game room, wherein the safety enclosure has a hole configured to couple with the camera.

In some embodiments, a game room, wherein the game room further includes an ejection target area.

In some embodiments, a game room, wherein the game room is in the shape of a rectangle.

In some embodiments, a game room, wherein the game room is in the shape of a square.

In some embodiments, a game room, wherein the ejection target area is disposed on one side of the game room and the ejection device and photobooth device are disposed on the opposing side of the game room.

In some embodiments, a game room, wherein the ejection orifices are configured to eject the ejection material toward the ejection target area.

In some embodiments, a game room, wherein the camera is configured to take a photo in response to an ejection of the ejection material.

In some embodiments, a game room, wherein the game room further includes a plurality of flash devices.

In some embodiments, a game room, wherein the flash devices are configured to coordinate flashing with the camera.

In some embodiments, a game room, wherein the game room is configured with a second game room.

In some embodiments, a game room, wherein the game room and second game room share a wall.

In some embodiments, a game room, wherein the game room is configured with at least one wall wherein the majority of the wall is included of glass.

In some embodiments, a game room, wherein the at least one wall of the game room is positioned adjacent to a viewing area.

In some embodiments, a game room, wherein the viewing area includes at least one display.

In some embodiments, a game room, wherein the display is configured to display images taken from the camera.

In some embodiments, a game room, wherein the game room is further configured with a door disposed on an opposing side of a wall included of a majority of glass.

In some embodiments, a game room, wherein the game room is further configured with a decontamination area.

In some embodiments, a game room, wherein the decontamination area is configured to allow washing off of ejection material.

In some embodiments, a game room, wherein the decontamination area is disposed outside of the game room.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a control system for an auto-refillable ejection device in accordance with various embodiments of the disclosure;

FIG. 2 is a photo of a pair of ejection tubes connected to various pressure generating devices and tubing in accordance with various embodiments of the disclosure;

FIG. 3 is an auto-refillable ejection device control panel in accordance with various embodiments of the disclosure;

FIG. 4 is a photo of various pressure generating regulators and tubing for the auto-refillable ejection device in accordance with various embodiments of the disclosure;

FIG. 5 is an auto-refillable ejection device prepared to eject ejection material on a plurality of players in accordance with various embodiments of the disclosure;

FIG. 6 is an auto-refillable ejection device ejecting foam-based ejection material on a plurality of players in accordance with various embodiments of the disclosure;

FIG. 7 is a plurality of players covered in a paint-based ejection material delivered from an auto-refillable ejection device in accordance with various embodiments of the disclosure;

FIG. 8 is a plurality of views of a game bomb room and photobooth system in accordance with various embodiments of the disclosure;

FIG. 9 is a dual game bomb room each with a wall with a glass wall and corresponding displays in accordance with various embodiments of the disclosure; and

FIG. 10 is a photobooth camera and safety enclosure in accordance with various embodiments of the disclosure.

FIG. 11 is a conceptual illustration of a device suitable for operating and executing a multi-purpose game logic in accordance with various embodiments.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that ejects ejection material on a plurality of players via one or more ejection tubes (i.e., cannons) that can be auto refilled from a cannister without intervention by a person. In many embodiments, this can be accomplished via one or more pumps, and can be configured for a variety of liquids and other substances (slime, polyurethane foam balls, etc.).

In a number of embodiments, the auto-refillable ejection device can be composed of a central air compressor (i.e., “main compressor”) as well as a back-up compressor. These compressors can be placed in a different room from the cannons in order to increase room design options. In these designs, hoses can be run to individualized air tanks per “tower”. In some embodiments, there can be five vertical towers, which can comprise pipes connected to a plurality of ejection orifices/cannons. The compressor(s) fill up the individualized air tanks to a pre-determined pressure (usually measured in pounds-per-square-inch). In more embodiments, this process can be digitally controlled via one or more hardware control box with an associated ejection device logic.

In a number of embodiments, each auto-refillable ejection device can be deployed within its own room (i.e., “bomb room”). Each bomb room can be paired with a control device that is configured to direct the auto-refillable ejection device via human direction. As discussed in more detail below, each control device can be equipped with a plurality of buttons associated with each available tower as well as an “arm all” button.

In various embodiments, the auto-refillable ejection device can be configured with a plurality of air tanks with corresponding solenoids, often disposed at the back of the air tanks to allow air to flow from the compressor(s) via one or more connecting tubes. The solenoids can be configured to close in response to the air tanks being full of air at the proper pressure. Subsequently, one or more of the towers can be filed with liquid or other eject-able material. In some embodiments, the tower can be connected by tubing to a piston-type device, which is itself connected to a “wand” or other material intake component configured to take eject-able material from a storage container into the auto-refillable ejection device system for use.

Upon filing of the “bomb” (via a button press, controller signal transmission, etc.), the pistons can, in various embodiments, pull a pre-determined number of times, which in turn pulls the eject-able material from the storage containers through the tubing into the piston, which then pushes it out of the piston into the hoses that are connected to the towers. The eject-able material can subsequently proceed through a one-way valve into a hollow vertical pipe. As those skilled in the art will recognize, the number of hoses utilized can vary based on the amount and variety of source eject-able material. For example, if the eject-able material was all uniform, all hoses could be sourced from a single storage container while unique eject-able materials can be sourced from a plurality of source containers. In additional embodiments, the auto-refillable ejection device can further activate a pump system that pulls material from a specialized reservoir of foam-like substance. This can be utilized as a mixture of a soapy solution with air to create foam, which can be processed through one or more of the towers.

In more embodiments, the control device can be equipped with “fire” buttons that can be utilized as triggers for the “bombs”. Specifically, they can open a second set of solenoids connecting the air tanks to the tower, which when the solenoid opens, lets out the air in the air tank, pushing the eject-able material currently sitting in the hollow chamber, through the tubing and through at least one ejection orifice. In some embodiments, this tubing may be comprised of polyvinyl chloride (“PVC”) piping. In various embodiments, the fire button may be triggered by a human operator of the interactive game. However, it is contemplated that some embodiments may have an automatic or machine-learning-based trigger that does not require human intervention. For example, it may be desired to verify that players/participants within the bomb room have their safety equipment on correctly and are standing in the correct location.

In still more embodiments, additional buttons on the control device may be provided to engage one or more clean-up processes. This can include, but is not limited to, flushing water through the system after closing the facility to the public for the day, etc. Additional management and/or wrap-up processes and procedures are contemplated and described in more detail below.

To capture this event, embodiments described herein can include an integrated photobooth camera system within the bomb room. In some embodiments, the bomb room is configured as a purpose-built specialty room whereby players are standing shoulder to shoulder, facing an auto-refillable ejection device. The players can engage in an interactive game within the room, and control it in various ways such as, but not limited to, holding a waterproof squeeze button controllers, which can be configured to function as input into one or more interactive games. In more embodiments, this game can be played by displaying gaming content on one or more televisions or monitors deployed within the bomb room. For example, in certain embodiments, the monitor(s) can be mounted to the wall above the auto-refillable ejection device and use mounted speakers in the room for audio.

In a number of embodiments, the bomb room can be equipped with a photo lighting system that can be configured such that placement anywhere in the room is possible, including in areas that may receive interactions from the eject-able material being ejected onto the player(s). To support this system, a series of high-lumen photography lights may be mounted within the bomb room. These can be triggered during the photo and/or video capture process. For example, the auto-refillable ejection device may have a countdown associated with it that indicates when it will expel the eject-able material. In these cases, the ejection trigger may be linked to a camera trigger within the photobooth system, such that the high-lumen lights come on and photos/videos are automatically captured without a human triggering that capture.

In further embodiments, the integrated photobooth system can be configured such that an output of the camera system is fed to an operator standing outside of the bomb room. This can ensure that the players are in frame correctly and that the camera is in focus to capture a sufficient image/video. As those skilled in the art will recognize, the capture can vary from still images to standard rate videos, high-definition videos, slow-motion videos, three-hundred sixty-degree videos and images, as well as sound, etc. These can be captured in any order or in any combination as desired by the operator, facility management, or the players themselves.

Subsequent to the auto-refillable ejection device ejecting the material onto the players, additional steps can be taken. For example, one or more water sources can be provided to help clean the players off. In some embodiments, the interactive game operator can enter the bomb room and utilize a standard hose to spray off the eject-able material off of the players. However, other methods of cleaning players post-ejection are contemplated. In certain embodiments, a drain system may be placed directly underneath or adjacent to the players such that water utilized to clean off the players can be easily flushed down the drain to aid in clean-up time, and thus increase the turnover rate in gameplay for other players.

Finally, in many embodiments, the photo and/or image data generated by the integrated photobooth system can be transmitted or otherwise provided to the players for viewing. This can be accomplished through one or more standard web services. In some embodiments, this data can be made public on a web page and be associated with other data such as team name, overall game score, number of victories, etc. In additional embodiments, the image and/or video data can be provided directly to the players privately, such as through a specialized application, or a private link to a web host, such that the link can be shared to third parties selected by the player.

Other aspects of the system are described below. For example, in some embodiments, the system may use waterproof squeeze button controllers to allow players to interact with the game. These controllers can function as inputs that trigger in-game actions, offering a tactile and responsive way for players to engage with the experience. Being waterproof, they could withstand the potential exposure to liquids during gameplay, which may be crucial in environments where ejection devices are in use.

In more embodiments, large televisions monitors or projectors might display the game content in the bomb room, making it visible to participants as they interact with the ejection device. For example, a seventy-five-inch television or an equivalent mounted projector could enhance the visual experience by providing clear, large-scale visuals of the ongoing game. This setup may also contribute to creating a more immersive environment, as players can focus on the game while anticipating the ejection event.

In further embodiments, a countdown timer may be employed to build anticipation before the ejection event. This timer might be accompanied by flashing lights and auditory cues such as beeping sounds, creating a heightened sense of urgency for the players. These effects could enhance the game's atmosphere and keep the players engaged right up to the moment of the ejection.

In additional embodiments, after the ejection event, the system could initiate an automated photo and video sequence. This feature may use integrated photobooth technology to capture slow-motion videos and still images, documenting the players' reactions post-ejection. The resulting media may be shared with participants as part of the overall game experience.

In still more embodiments, high-lumen photo lights might be installed in the bomb room to ensure high-quality images are captured during gameplay. These lights could automatically activate during key moments, such as the ejection event, to illuminate the space. The lighting may enhance the clarity of the photos and videos taken, making them suitable for sharing and viewing afterward.

In yet further embodiments, the system may take six photos in total after the ejection, with some using standard lighting and others captured under a blacklight. This variety could provide players with a range of images that capture different aspects of the experience. The use of a blacklight effect might offer a unique visual style, making the post-ejection photos even more dynamic and fun.

In various embodiments, after the ejection event, players may be prompted to engage in a celebratory dance such as a specific dance sequence while fun, high-energy music plays. The system could capture a short video of the players dancing, adding a lighthearted and celebratory element to the game. This video might become a memorable takeaway for participants, offering them a personalized, entertaining moment to share.

In a number of embodiments, a decontamination process might be incorporated into the experience, allowing players to be hosed down after being covered in ejection material. The system may include a hose connected to a spigot within the bomb room, which could be used to rinse off the participants while they stand on a trench drain. This process might not only clean the players but also make for a smooth transition between game sessions.

In more embodiments, the floor of the bomb room could feature a trench drain system designed to handle the liquids involved in the game, such as water or paint. Positioned at the back of the room, the trench drain may slope downwards to collect and remove excess material efficiently. This design might prevent water and paint from pooling and ensure quick cleanup after each game session.

In still additional embodiments, the decontamination room could be located outside the bomb room, equipped with industrial-grade stainless steel sinks. These sinks might allow players to further clean up after the hosing process, ensuring they are free of ejection material before leaving the area. The stainless-steel construction might be chosen for its durability and resistance to rust or mold.

In some embodiments, replay walls might display video replays of the game using short-throw projectors. These projectors could be positioned to show the footage captured by the photobooth system, offering players the chance to relive key moments from their game. This feature could enhance the overall experience, as participants may enjoy watching their reactions immediately after the event.

In yet more embodiments, after the game, players' performance statistics may be displayed on leaderboard screens. These screens could show scores, game outcomes, and other metrics, allowing teams to compare their results with others. The real-time display of stats might add a competitive element to the experience, motivating players to improve on future attempts.

In numerous embodiments, following the game, participants might receive emails or text messages containing links to their personalized media content. These links could direct them to a web page or cloud storage platform where they can view and share their photos, videos, and game stats. The system could be designed to automatically distribute this media soon after the game concludes, ensuring a seamless experience.

In some embodiments, in addition to digital media, a physical score sheet might be printed at the front desk for each team. This score sheet could summarize the game's results, including the team's performance in various challenges. Having a tangible record of their game might enhance the players' connection to the experience and serve as a keepsake.

In certain embodiments, the ejection towers may be filled with paint through a piston and wand system. This mechanism could draw paint from reservoirs into the towers, ensuring a consistent supply of ejection material. The piston system might offer a reliable and efficient way to handle thick, viscous substances like paint, ensuring the ejection device operates smoothly.

In a number of embodiments, for foam-based ejections, the system might use a pump system to fill the towers with a soapy foam mixture. This pump could mix air with the foam solution to create the desired consistency before it is ejected through the towers. The foam may add a playful and tactile element to the game, enhancing the sensory experience for participants.

In some embodiments, the PVC cannon arms may be adjustable, allowing operators to set the angle of ejection based on the height or positioning of the players. This adjustability could ensure that the ejection material is directed appropriately, whether players are children or adults. The ability to move the cannons might make the system more versatile, accommodating different groups and room setups.

In still further embodiments, the control device could include safety switches that must be engaged for the ejection device to function. These switches may ensure that the system cannot be triggered accidentally, adding an extra layer of security. This design might be essential in maintaining player safety, as it prevents unauthorized or premature activation of the ejection device.

In still yet more embodiments, a manager's key might be required to activate the control box, ensuring only authorized personnel can operate the ejection device. This key system could serve as an additional safeguard, preventing the system from being used without supervision. By limiting access, the manager's key might help maintain safety protocols and reduce the risk of mishaps during gameplay.

In further additional embodiments, the ejection device could be designed with multiple orifices to cover the full width of the bomb room. This configuration might ensure that no matter where players are standing, they cannot avoid the ejection material. The full coverage design could make the game more thrilling and immersive, as players must embrace the ejection without the ability to dodge.

In various embodiments, the system might include a mechanism to clean the towers and pipes with water after each session. This feature could involve flushing water through the system to remove any residual paint or foam, ensuring the equipment is ready for the next group of players. Regular cleanups may help maintain the longevity and efficiency of the ejection device, reducing the likelihood of clogs or malfunctions.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

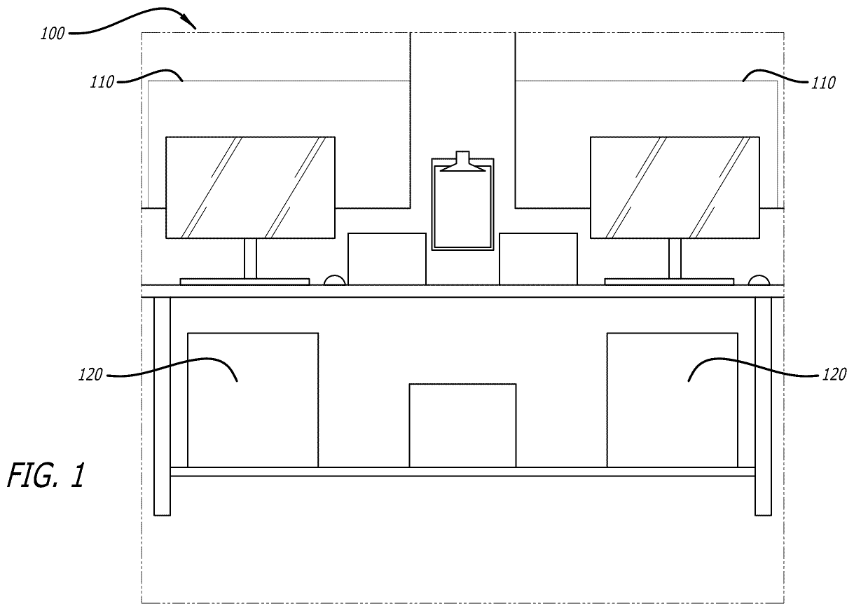

The embodiment depicted in FIG. 1 illustrates a control system 100 for an auto-refillable ejection device, featuring components such as bomb rooms 110 and control devices 120 deployed in a dual-room layout. In various embodiments, the bomb rooms 110 may be specialized spaces designed to house the auto-refillable ejection device. These rooms could be used for interactive gameplay, where participants engage with both physical and digital elements. For example, the ejection device may release materials such as paint, slime, or foam onto the players. In more embodiments, the bomb rooms 110 might also incorporate a photobooth system, allowing for the capture of images or videos during the ejection process. This could create a dynamic blend of physical interaction and digital recording, enhancing the overall experience.

In a number of embodiments, the control system 100 can include control devices 120 that help manage the operations of the auto-refillable ejection device. These devices may control aspects such as air pressure and the ejection mechanism, giving operators or automated systems the ability to initiate the ejection of materials. In some embodiments, the control devices 120 may feature buttons for manual interaction, allowing for the adjustment of timing and intensity of the ejections. Alternatively, these systems could be more automated, with the devices monitoring and adjusting operations such as tank refills, air management, and material ejections based on inputs from either game logic or human users.

In still more embodiments, the bomb rooms 110 can be designed to provide an immersive experience, combining physical interactions with real-time feedback. Players might face the ejection device as part of an interactive game, with the release of materials serving as a climactic element. These rooms may also include digital displays or monitors to provide visual feedback and enhance the experience, helping to integrate the physical gameplay with game objectives. The setup could accommodate multiple players simultaneously, making the experience more engaging and collaborative.

Photobooth systems integrated into the bomb rooms may add another layer to the interactive experience by allowing players to capture and share their moments of participation. High-lumen lighting systems could ensure that even fast-paced moments are well-lit and clear in the images or videos. The system might be programmed to automatically trigger captures at key moments, such as just before or during material ejection. These images or videos could then be viewed or shared by the participants, potentially through various platforms, or used in the game's scoring and ranking system, making the overall experience more interactive and memorable.

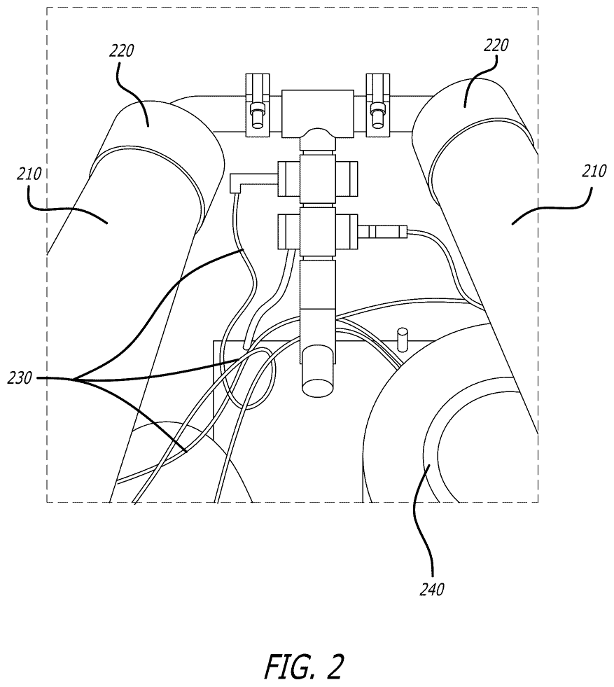

Although a specific embodiment for a control system for an auto-refillable ejection device suitable for carrying out the various steps, processes, methods, and operations described herein is discussed with respect to FIG. 1, any of a variety of systems and/or processes may be utilized in accordance with embodiments of the disclosure. For example, the control system 100 may include any number of bomb rooms 110 and may be controlled via separate or a unified control system. The elements depicted in FIG. 1 may also be interchangeable with other elements of FIGS. 2-11 as required to realize a particularly desired embodiment.

Referring to FIG. 2, a photo of a pair of ejection tubes 210 connected to various pressure generating devices and tubing in accordance with various embodiments of the disclosure is shown. In various embodiments, the ejection tubes 210 comprise a second end 220 which is connected to a plurality of valves, piping, or other ejection material regulators. (The ejection tubes 210 may also comprise a first end (not shown) which may be an ejection orifice.) These valves and piping can be connected to a plurality of tubes 230 which can be configured to be placed within one or more canisters 240 which may contain ejection materials. Each of these components may be in communication with the control system.

The embodiment depicted in FIG. 2 illustrates a system involving ejection tubes 210, second ends 220, a plurality of tubes 230, and one or more canisters 240, all potentially contributing to the material ejection process. The ejection tubes 210 may serve as conduits for ejecting material onto players or within an interactive game environment. In some configurations, the ejection tubes could be connected to pumps or valves that regulate the flow of material. The second ends 220 of these tubes are typically positioned to connect to additional system components that manage the input of ejection material. Various embodiments may have the conduits and ejection tubes configured as flexible tubes or pipes. However, in some embodiments, the conduits and/or ejection tubes 210 can be configured from stiff piping, such as PVC piping, etc. These stiffer embodiments can still be adjusted via one or more pivot points or joints configured on one of the ends of the ejection tubes 210.

At the second end 220 of the ejection tubes 210, various control mechanisms can be integrated. These ends might be linked to valves or piping designed to manage the pressure and volume of the ejection material, ensuring precise operation during gameplay or interactive experiences. The use of these control points can allow for adjustments in the material's speed or pressure, depending on the game or application requirements. The second end might also ensure that eject-able materials, or other substances are efficiently processed through the tubes 210.

The plurality of tubes 230 depicted may serve as critical pathways for transferring the ejection material from storage canisters to the main ejection tubes. These tubes can be designed to handle a variety of substances, from liquids to more viscous materials like foam. The connections between the tubes may involve several valves and regulators that allow the system to control the flow dynamically. These components can work together to ensure that the material is delivered smoothly to the ejection point, whether it is for a single-use or multiple events in a game setting.

One or more canisters 240, as illustrated, may be where the ejection material is stored before being transferred through the tubes. These canisters could hold a variety of materials, depending on the intended interactive experience. The system might include sensors or other devices that monitor the amount of material left in the canister, ensuring the auto-refillable feature can operate without human intervention. The connection between the canisters and the ejection system may also involve pumps or pressurized air tanks to facilitate the flow of material to the tubes.

Although a specific embodiment for a photo of a pair of ejection tubes connected to various pressure generating devices and tubing suitable for carrying out the various steps, processes, methods, and operations described herein is discussed with respect to FIG. 2, any of a variety of systems and/or processes may be utilized in accordance with embodiments of the disclosure. For example, the layout of the ejection tubes 210, valves, piping, and/or tubes 230 can be adjusted based on various desired applications. The elements depicted in FIG. 2 may also be interchangeable with other elements of FIGS. 1 and 3-11 as required to realize a particularly desired embodiment.

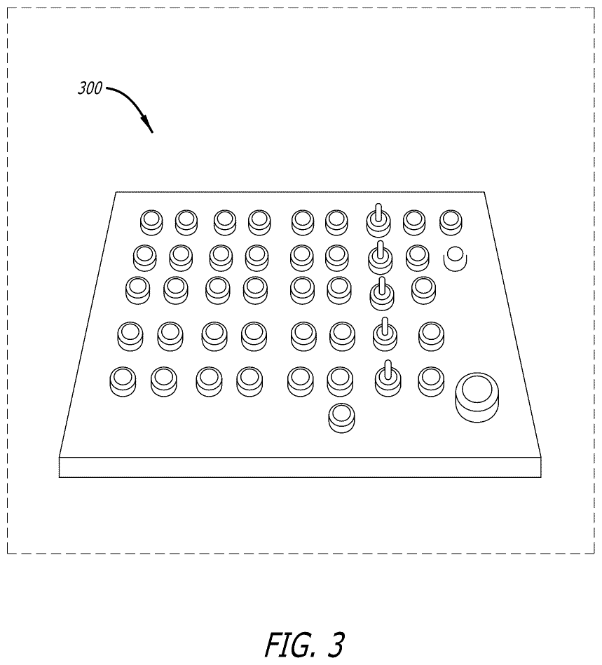

Referring to FIG. 3, an auto-refillable ejection device control panel 300 in accordance with various embodiments of the disclosure is shown. In many embodiments, the auto-refillable ejection device control panel 300 can be configured with a plurality of status lights and or engagement switches, buttons, or latches. The status lights can be configured to signal the various stages of ejection, refilling, pressure build-up, and readiness of the ejection device.

The control device panel 300, as depicted in FIG. 3, may serve as the central control system for operating an auto-refillable ejection device. The panel can be designed with a plurality of switches, buttons, latches, and status lights that may indicate the various operational stages of the ejection system. The arrangement of controls may be optimized to ensure ease of use for an operator, allowing for quick and precise manipulation of the ejection device during interactive gameplay or other events. The variety of control elements present suggests a wide range of operational functions could be managed through this interface.

The status lights, as described, may provide real-time feedback to the operator regarding the system's current condition. For example, one set of lights could indicate when the pressure build-up in the system has reached the necessary level for safe ejection, while another set may signal when the refilling process is underway. These lights can help prevent errors or accidents by providing clear visual cues about the system's readiness. Such indicators could also reduce the need for constant manual checks of the ejection system, automating parts of the operational oversight.

The buttons and switches on the control panel may be linked to different stages of the ejection process, allowing the operator to engage or disengage specific functions. For instance, a switch could be used to initiate the pressure build-up in the air tanks, while a button might be pressed to release the ejection material through the connected tubes and cannons. Some buttons could be dedicated to arming or disarming certain sections of the ejection device, giving the operator the ability to control the ejection from multiple points if necessary. These controls may be responsive and designed to give immediate feedback upon use.

In some configurations, the control device panel 300 could include fail-safes or emergency stop buttons, ensuring that the ejection process can be halted if needed. Additionally, the control system may integrate with a broader network of control devices, allowing for coordinated actions across multiple ejection devices or bomb rooms. The combination of visual indicators and physical control elements on this panel likely creates an intuitive interface for managing complex ejection scenarios, reducing the likelihood of operator error and ensuring that the device functions smoothly.

Although a specific embodiment for an auto-refillable ejection device control panel suitable for carrying out the various steps, processes, methods, and operations described herein is discussed with respect to FIG. 3, any of a variety of systems and/or processes may be utilized in accordance with embodiments of the disclosure. For example, the auto-refillable ejection control device panel 300 can be configured in any size or arrangement as necessary to convey the necessary information and provide the desired actionable engagement methods. For example, the auto-refillable ejection control device panel 300 can be implemented as a software-based system. The elements depicted in FIG. 3 may also be interchangeable with other elements of FIGS. 1-2 and 4-11 as required to realize a particularly desired embodiment.

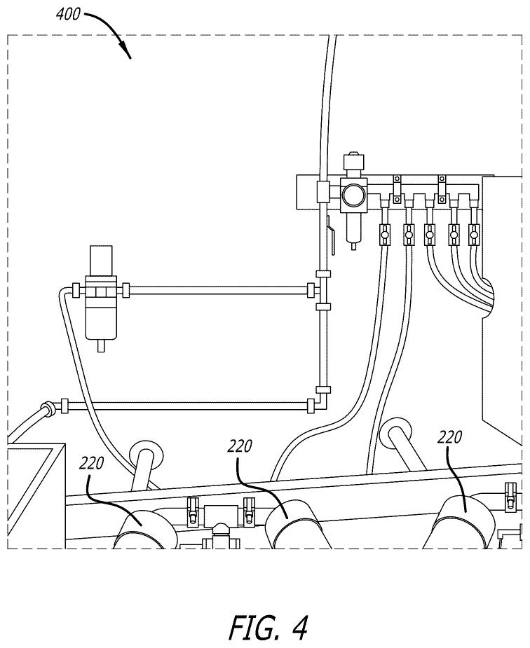

Referring to FIG. 4, a photo of various pressure generating regulators and tubing 400 for the auto-refillable ejection device in accordance with various embodiments of the disclosure is shown. In the embodiment shown in FIG. 4, a plurality of ejection tubes are shown with corresponding second ends 220 which are connected to various valves, tubes, or other regulators. This system can be configured to generate or otherwise safely control the generation or build-up of pressure which can be utilized to eject the ejection material form the ejection tubes.

The embodiment depicted in FIG. 4 showcases an intricate system of pressure-generating regulators and tubing 400, which can play a role in controlling the flow and ejection of materials in the auto-refillable ejection device. The second ends 220 of the ejection tubes are clearly seen connected to multiple components, such as valves, solenoids, and tubes, which may regulate the pressure and ensure a steady and safe material ejection process. These regulators may assist in building up or controlling the internal air pressure needed for the system to operate efficiently and with precision.

The second ends 220, which are part of the ejection tubes, may be responsible for channeling the air pressure or the ejection material into the proper direction for expulsion. As shown in FIG. 4, these ends are interconnected with a series of tubes that likely guide the material from a central pressure source or a storage container to the ejection orifices. This network of tubes and regulators may be designed to ensure the safe transfer of the material while maintaining the necessary pressure levels to enable effective ejection. The system might include built-in safety mechanisms that could automatically release excess pressure or prevent malfunctions in case the pressure exceeds certain limits.

The pressure-generating components in the figure might also include advanced regulators that can allow for variable levels of pressure depending on the type of ejection material being used. For instance, different materials, such as foam or liquid, may require distinct pressure levels to achieve optimal ejection. These regulators may work in tandem with the control devices mentioned previously to adjust the pressure settings in real-time or based on pre-set configurations. Additionally, machine learning algorithms may be integrated to monitor the performance of these pressure regulators, automatically adjusting the system for efficiency and minimizing the risk of over-pressurization or underperformance.

Lastly, the interconnections between the second ends 220 and the tubing in this system can provide insights into the system's overall complexity and flexibility. The various tubes seen in FIG. 4 may allow the ejection device to support multiple materials, with the second ends functioning as junction points where pressure and material converge before ejection. This level of control and modularity can allow the system to be adaptable, making it suitable for various applications, ranging from gaming environments to industrial uses. Through this configuration, operators can manage different ejection sequences, likely ensuring that each material is dispensed at the correct pressure and volume.

Although a specific embodiment for a photo of various pressure generating regulators and tubing for the auto-refillable ejection device suitable for carrying out the various steps, processes, methods, and operations described herein is discussed with respect to FIG. 4, any of a variety of systems and/or processes may be utilized in accordance with embodiments of the disclosure. For example, the configuration can be in any shape or size depending on the application desired. For example, the configuration of tubing, piping, etc. can be in response to allow for ease of access to various components for troubleshooting, maintenance, etc. The elements depicted in FIG. 4 may also be interchangeable with other elements of FIGS. 1-3 and 5-11 as required to realize a particularly desired embodiment.

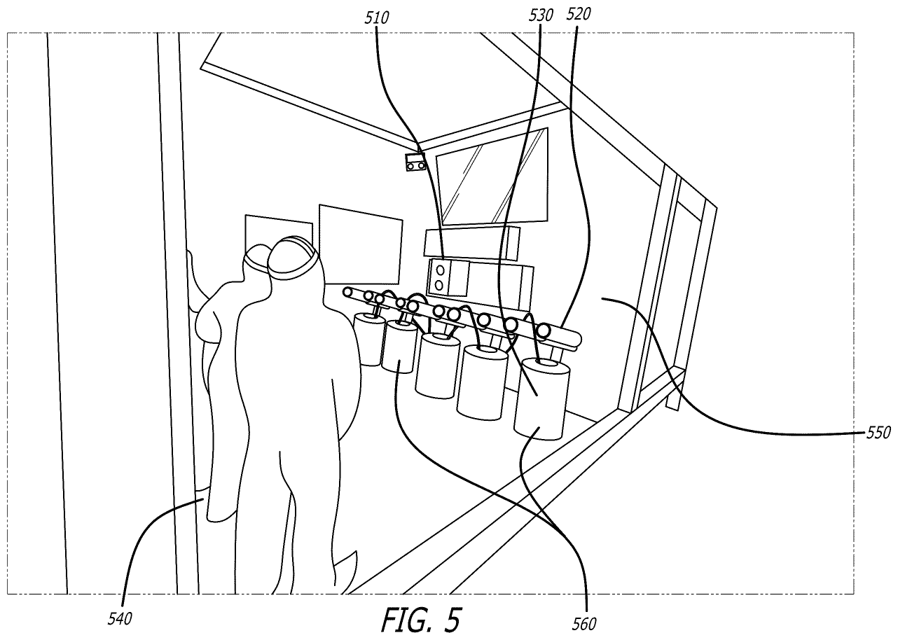

Referring to FIG. 5, an auto-refillable liquid ejection device 560 prepared to eject ejection material on a plurality of players in accordance with various embodiments of the disclosure is shown. In many embodiments, the bomb room is configured as a square or rectangular room with two opposing sides including an ejection target area 540 and an opposing side 550 that includes an auto-refillable liquid ejection device 560 comprising a series of ejection tubes 520, cannisters 530 holding ejection material suitable for auto-refilling into the ejection tubes 520, and a camera system 510.

In a number of embodiments, the players are deployed onto the ejection target area 540 during the course of a game. The game can include gameplay shown on a display in the bomb room. The players can interact with the game, such as with a waterproof squeezable controller. Upon completion of the game, or upon expiration of time, or other game mechanic, the bomb may be “detonated” which ejects the ejection material onto the players in the ejection target area 540. After the ejection, the ejection tubes 520 may then be refilled from ejection material within the cannisters 530. This process can be automatic or may be directed by an administrator from a controller or corresponding logic.

The embodiment depicted in FIG. 5 illustrates an auto-refillable ejection device 560 placed within a room designed for interactive gameplay or immersive experiences. This ejection device 560 can be configured to launch various materials onto participants, likely standing in an ejection target area 540. The ejection device 560 may include a series of ejection tubes 520, which are positioned to release the ejection material towards the players. These tubes could act as the main ejection orifices through which the material is expelled, and they are likely fed by the connected canisters 530 that store the material.

In more embodiments, the camera system 510 visible in FIG. 5 could be responsible for capturing the action inside the room, allowing the players to relive the experience through recorded images or videos. This system might be mounted in a way that provides a comprehensive view of both the players and the auto-refillable ejection device. The camera system 510 may trigger automatically, capturing key moments like the exact point of material ejection, and it could be integrated into the control logic to synchronize with the ejection process.

The canisters 530, which are located just above the ejection tubes 520, can serve as the source of the materials being ejected. These canisters could be configured to automatically refill the ejection tubes, making the process smooth and continuous without the need for manual intervention. The material inside these canisters may vary based on the type of game or experience being facilitated. They might hold eject-able substances such as foam, slime, or other playful ejection materials, and this variety could offer a more dynamic and engaging experience for the players.

On the opposing side 550 of the room, the players might stand in the designated ejection target area 540. This area may be strategically positioned to ensure that players are fully immersed in the interactive experience. The layout could be designed for optimal coverage from the ejection device, ensuring that the players are in the correct zone to receive the ejection material. The overall setup, as seen in the figure, suggests a room where the auto-refillable ejection device is the central feature, providing an interactive and engaging experience while being captured by the integrated camera system.

Although a specific embodiment for an auto-refillable ejection device prepared to eject ejection material on a plurality of players suitable for carrying out the various steps, processes, methods, and operations described herein is discussed with respect to FIG. 5, any of a variety of systems and/or processes may be utilized in accordance with embodiments of the disclosure. For example, the shape of the bomb room may change in response to various desired applications. This may include a circular bomb room, triangular bomb room, or the like. The elements depicted in FIG. 5 may also be interchangeable with other elements of FIGS. 1-4 and 6-11 as required to realize a particularly desired embodiment.

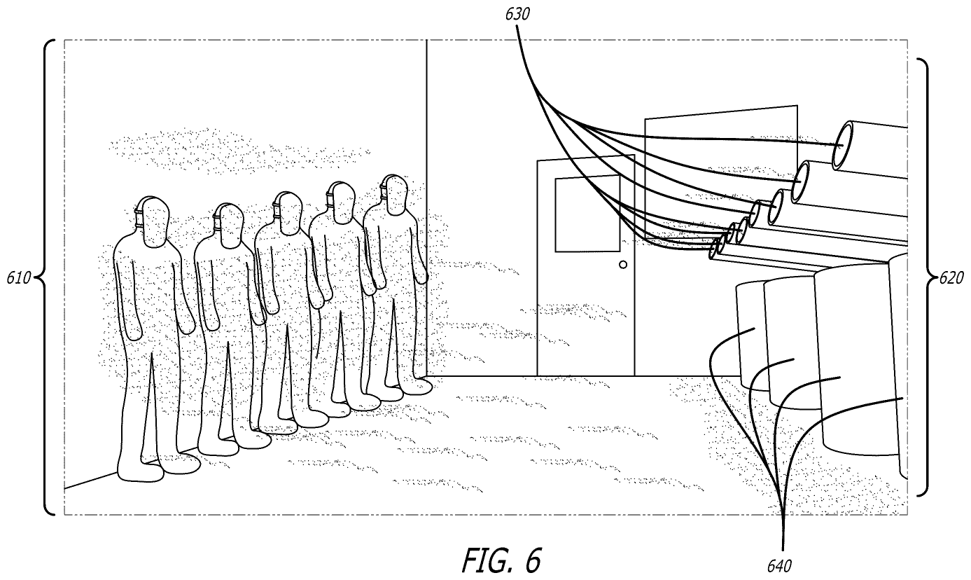

Referring to FIG. 6, an auto-refillable ejection device 620 ejecting foam-based ejection material on a plurality of players in accordance with various embodiments of the disclosure is shown. In many embodiments, the ejection of the ejection material can occur from a series of ejection orifices 630 disposed on one end of an ejection tube. This can be from an auto-refillable ejection device 620 aimed at a target ejection area 610. In the embodiment depicted in FIG. 6, the players are exposed to a blast of foam-based ejection material.

In the embodiment depicted in FIG. 6, the auto-refillable ejection device 620 may be designed to eject foam-based ejection material onto players standing in the designated target ejection area 610. In a number of embodiments, this device could utilize various components as those described herein, including multiple ejection orifices 630 that are configured to release the ejection material in a coordinated fashion. The ejection device may be capable of refilling automatically from its canisters 640, which could store a variety of various eject-able materials. This design might allow for consistent gameplay with minimal manual intervention to reload the system.

The ejection orifices 630 could be arranged in such a way that they are capable of providing broad coverage of the target ejection area 610. These orifices may be controlled by a pressure system that coordinates the timing and force of the ejection, potentially allowing for varying intensities of foam blasts. The layout seen in the figure suggests that these orifices 630 could be positioned at varying angles to ensure that the entire target area is covered, engaging all participants at once.

Each canister 640 may be tasked with holding a specific volume of ejection material, likely foam in this case, and could be connected to the ejection orifices 630 through tubing. These canisters 640 could refill the ejection device automatically, maintaining an uninterrupted supply of material. Depending on the game's requirements, different materials such as liquid or lightweight objects could be stored in the canisters 640, enabling versatile game designs.

In terms of gameplay, the target ejection area 610 can represent the space where players may be situated, waiting for the ejection material to be released from the device. The placement of players in this area might allow for immersive experiences where they are fully engaged in the game. Depending on the settings, this area could be adjusted to accommodate different game dynamics, such as adjusting the intensity or duration of the ejection material. This may provide a balance between entertainment and physical engagement within the bomb room environment.

Although a specific embodiment for an auto-refillable ejection device ejecting foam-based ejection material on a plurality of players suitable for carrying out the various steps, processes, methods, and operations described herein is discussed with respect to FIG. 6, any of a variety of systems and/or processes may be utilized in accordance with embodiments of the disclosure. For example, the auto-refillable ejection device 620 can be configured to make multiple ejections without the need to have a person refill or otherwise intervene with the system. The elements depicted in FIG. 6 may also be interchangeable with other elements of FIGS. 1-5 and 7-11 as required to realize a particularly desired embodiment.

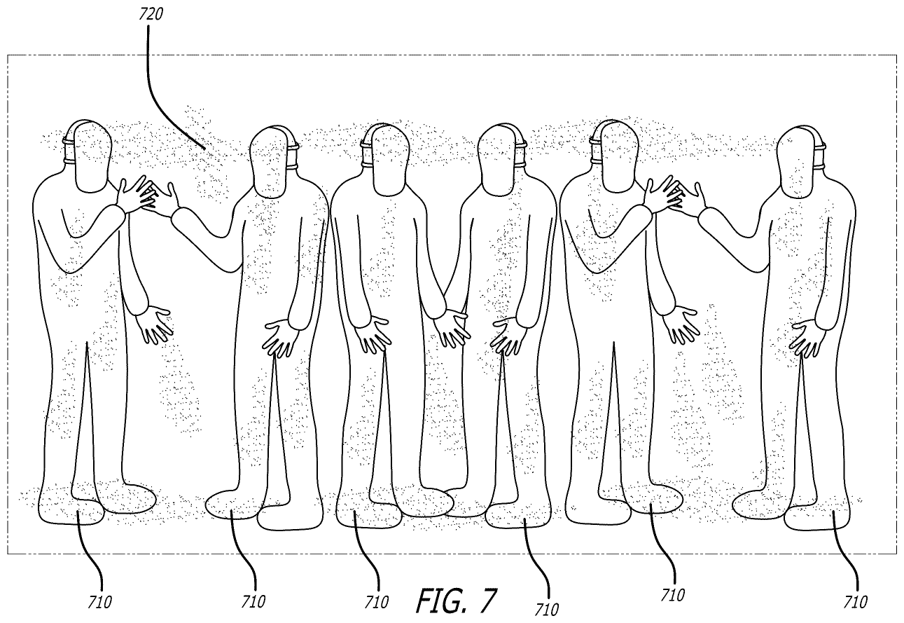

Referring to FIG. 7, a plurality of players 710 covered in an ejection material 720 delivered from an auto-refillable ejection device in accordance with various embodiments of the disclosure is shown. The embodiment depicted in FIG. 7 shows a post-ejection state wherein the plurality of players 710 are able to celebrate or otherwise react to the ejection of the ejection material 720. The ejection material 720 in the embodiment depicted in FIG. 7 can be a paint-based material, which may be configured to be a variety of different colors. However, as described herein, other eject-able materials may be utilized as desired. Indeed, each canister of the auto-refillable ejection device can be a different color or material, which may feed a plurality of ejection tubes.

The embodiment of FIG. 7 depicts a group of players 710 covered in ejection material 720 following the release of the material from an auto-refillable ejection device. The shading used in the figure is meant to indicate the presence of the ejection material 720, which is spread across the players and the bomb room environment, suggesting a post-ejection moment of interaction or celebration. This can highlight how ejection events may involve various substances, offering an immersive and engaging experience for the participants. The shading in the figure may further illustrate that the ejection material 720 may be evenly distributed across multiple players, indicating an effective coverage area that enhances the collective nature of the experience.

The players 710 are shown standing in a group, and their body language suggests that they are engaging with one another after being covered in the ejection material 720. This interaction can reflect the social aspects of such interactive game experiences, where players are not only engaged by the physical sensation of the ejection material but may also enjoy the communal aspect of shared excitement. The nature of the ejection material can vary, and this may depend on the type of game being played, the material stored in the canisters, and the preferences of the participants or operators.

The ejection material 720, as depicted in this embodiment, may be a paint-based substance, as described above, but it can also be a variety of other materials. For example, foam, slime, or even confetti-like substances can be used to create different atmospheres and cater to different player experiences. The ability to use different materials adds flexibility to the system, allowing it to accommodate a wide range of game scenarios or themes, such as competitive team events or more lighthearted, casual interactions.

In addition, the overall system or ejection device logic that coordinates the release of the ejection material can be controlled via a combination of automated triggers and manual inputs. This allows for adaptability in the deployment of the material and its precise release onto the players. Given that the system is auto-refillable, it can ensure minimal downtime between ejections, allowing multiple rounds of gameplay with varying materials, each offering a unique experience for the players 710 as they react and interact with the ejection material 720.

Although a specific embodiment for a plurality of players covered in a paint-based ejection material delivered from an auto-refillable ejection device suitable for carrying out the various steps, processes, methods, and operations described herein is discussed with respect to FIG. 7, any of a variety of systems and/or processes may be utilized in accordance with embodiments of the disclosure. For example, the ejection material 720 can be ejected on a portion of the plurality of players 710 or over a larger area as desired. The elements depicted in FIG. 7 may also be interchangeable with other elements of FIGS. 1-6 and 8-10 as required to realize a particularly desired embodiment.

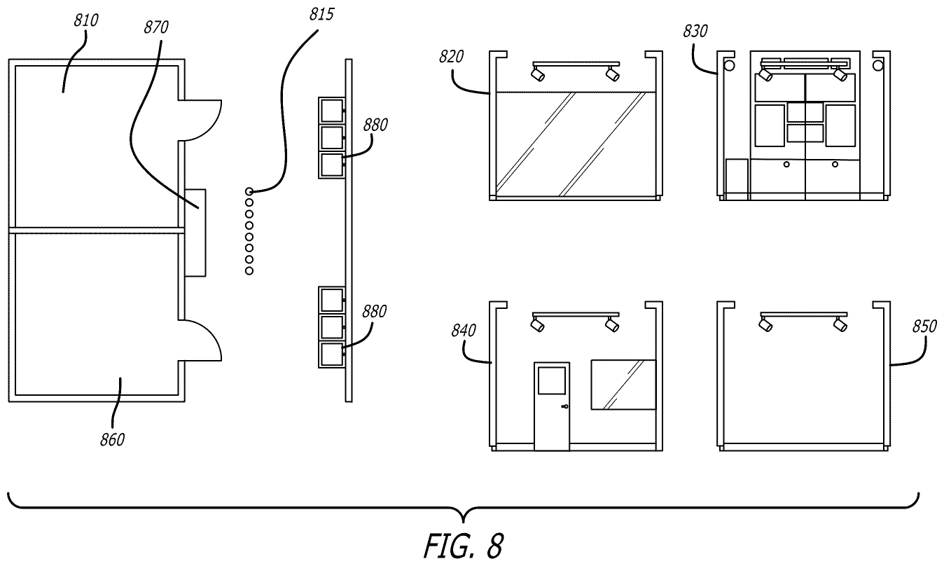

The embodiment shown in FIG. 8 also depicts a second wall view 830 which may comprise a plurality of displays, an auto refillable liquid ejection device (shown as “bomb”) and a plurality of camera systems. A third wall view 840 can depict a wall with a doorway and a second window that can be configured to allow viewing from a control area where a controller or other administrator can view inside of the bomb room. Finally, the fourth wall view 850 is considered the target ejection area where the ejection materials of the “bomb” are ejected onto. Often, a plurality of players are standing or otherwise situated against this wall.

The embodiments shown in FIG. 8 present a variety of detailed layouts of a bomb room and photobooth system, highlighting various views of the room. The top view 810 depicts the overall layout of two bomb rooms separated by a control area and a decontamination area. This bird's-eye perspective provides a useful overview of how the rooms may be arranged and showcases the functional areas. The bomb rooms, which are equipped with auto-refillable ejection devices, are where players engage in the interactive game experience. The control area allows technicians to monitor and control the gameplay, while the decontamination area can be used for post-game clean-up.

The first wall view 820 illustrates a wall that predominantly consists of a glass window, allowing observers outside the bomb room to view the action. This glass wall can serve both practical and entertainment purposes, enabling spectators to watch the players as they participate in the game. The viewing area can enhance the excitement for external participants while also allowing game operators to oversee the room from a distance.

The second wall view 830 focuses on the interactive technology within the room. It may include multiple display screens, an auto-refillable liquid ejection device (referred to as the “bomb”), and an integrated camera system. The displays can be used to communicate with the players, show game content, or countdowns. The “bomb” device can be responsible for ejecting materials onto the players, while the camera system captures the experience, possibly for later viewing or sharing.

Finally, the third wall view 840 and fourth wall view 850 display important functional aspects. The third wall view 840 features a door and a window that could allow a game technician to view the players inside the room. This area may provide a secondary perspective for control and safety purposes. The fourth wall view 850, often the target ejection area, is where the players stand or sit to receive the ejection material. This wall can be specially designed to accommodate the unique gameplay and ensure safe and effective ejection of the materials.

Although a specific embodiment for a plurality of views of a game bomb room and photobooth system suitable for carrying out the various steps, processes, methods, and operations described herein is discussed with respect to FIG. 8, any of a variety of systems and/or processes may be utilized in accordance with embodiments of the disclosure. For example, the overall layout shown in FIG. 8 may be adjusted based on the desired need. It is contemplated that multiple bomb rooms can be situated from a centralized control room. The elements depicted in FIG. 8 may also be interchangeable with other elements of FIGS. 1-7 and 9-11 as required to realize a particularly desired embodiment.

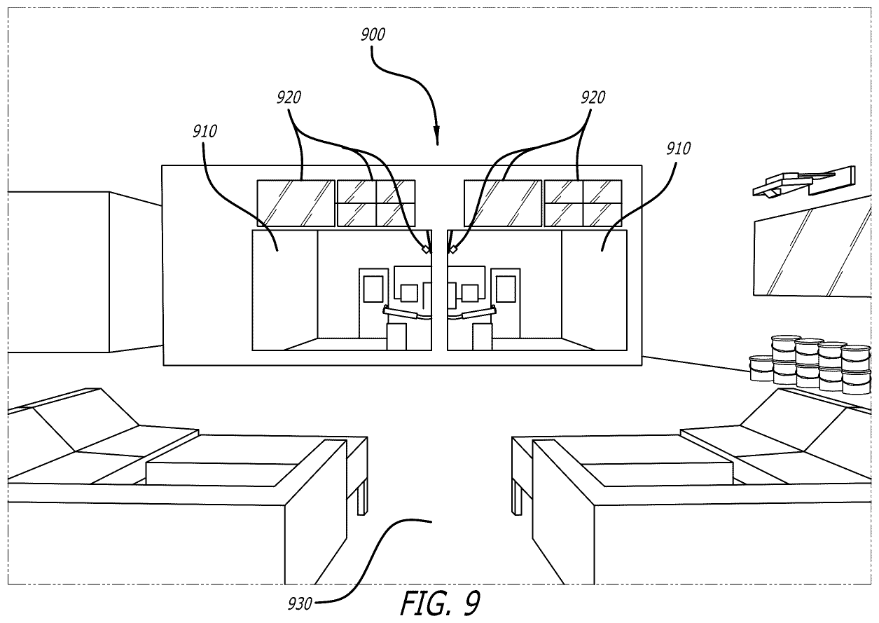

Referring to FIG. 9, a dual game bomb room layout 900 each with a wall with a glass wall 910 and corresponding displays 920 in accordance with various embodiments of the disclosure is shown. In many embodiments, the bomb rooms may be situated with one or more glass walls that allow for viewing within the rooms from a viewing area. The viewing area can be from people or players that are waiting to play a game or are otherwise attending the game area. This layout can entice non-players to play the game and increase sales. Each of the game rooms can share a wall as well as have a pair of corresponding displays 920. The displays 920 can be configured to show various events or data such as previous bomb explosions, replays, slow motion videos, still pictures, scores, game state statuses, etc.

The embodiment depicted in FIG. 9 illustrates a dual bomb room layout 900, highlighting key features such as the glass walls 910 and corresponding displays 920 for each room. The bomb rooms may be designed with a layout that allows participants and non-participants to observe the activities within through the glass walls 910, which could enhance the engagement of those outside the game. These walls create a visual link between the inside action and potential spectators, offering them a firsthand look at the gameplay, which might entice them to participate or encourage others to do so. The presence of such viewing areas may foster a more immersive and exciting atmosphere in the overall interactive game facility.

In many embodiments, the displays 920 play a pivotal role in amplifying the game experience by showing dynamic content related to the game being played in each bomb room. These displays 920 can be situated above or near the glass walls, offering clear visibility to both players and spectators. The content displayed can vary from live game feeds to highlights such as slow-motion replays, scores, or even real-time feedback about the game state. This setup can enhance the experience for those inside the game room, as well as for those observing from the outside, providing everyone with a more comprehensive and entertaining perspective of the game.

In various embodiments, the dual bomb room layout 900 may also provide an efficient and exciting use of space, allowing two separate games to take place simultaneously. Each room can be isolated from the other, yet the shared wall and similar configuration allow for centralized control and management of both rooms. This can increase the flow of participants through the facility, enabling more people to engage with the game. Additionally, this layout may serve as a compelling design choice for maximizing spectator involvement, as it creates multiple points of interest for those in the viewing area.

Seating areas like the one depicted in the foreground of the embodiment shown in FIG. 9 may be strategically placed for spectators or waiting participants to enjoy the game from a distance. This comfort-focused design can further enhance the overall experience by providing a relaxed environment while still maintaining a close connection to the action happening in the bomb rooms. Whether players are watching their friends or preparing for their own turn, these spaces may contribute to a well-rounded entertainment experience within the interactive gaming facility.

Although a specific embodiment for a dual game bomb room each with a wall with a glass wall and corresponding displays suitable for carrying out the various steps, processes, methods, and operations described herein is discussed with respect to FIG. 9, any of a variety of systems and/or processes may be utilized in accordance with embodiments of the disclosure. For example, the viewing area can be configured as shown in FIG. 9, but may also include a bar area, kitchen, table seating, or other arrangement of entertainment venue. The elements depicted in FIG. 9 may also be interchangeable with other elements of FIGS. 1-8 and 10-11 as required to realize a particularly desired embodiment.

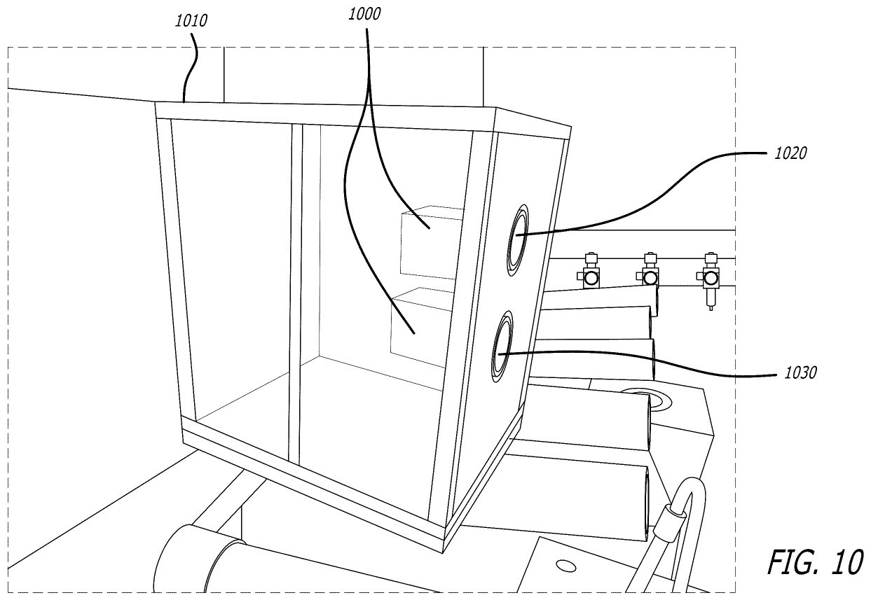

Referring to FIG. 10, a photobooth camera 1000 and safety enclosure 1010 in accordance with various embodiments of the disclosure is shown. A camera system within the bomb room can allow for capturing of still pictures or video data. This may require the use of multiple cameras 1000 as each type of data may be fed to different locations for processing. For example, still pictures may be stored and sent to a cloud-based service for sharing with the players and on various social media platforms. The video feed may be processed and captured to generate slow-motion clips which can be fed and played on the displays in the viewing area, but may also be shared with the players through a specialized link that is emailed to the player after the game once they are ready for consumption. The player may be onboarded with various data such as an email that can be used to send the still and video data to.

The embodiment depicted in FIG. 10 shows an intricate setup involving a photobooth camera system 1000 enclosed in a safety enclosure 1010, designed for capturing photos and videos during interactive gameplay. The camera system may consist of multiple cameras 1000 strategically placed to capture different types of data. For instance, some cameras may focus on still images, while others may handle video feeds. These cameras can be mounted inside the bomb room, allowing for real-time capture of the player experience during the game.

The safety enclosure 1010 may serve a dual purpose. First, it can protect the photobooth cameras 1000 from potential damage caused by the chaotic nature of the game. Since players are exposed to various ejection materials, the cameras need to be shielded from these materials while still capturing clear footage. Second, the enclosure may also help organize the system by containing all related components in a structured and accessible manner, ensuring smooth functionality without external interference.

Each camera 1000 in the system may be equipped with a lens hole. The figure illustrates two such holes; a photo lens hole 1020 and a video lens hole 1030. However, it is contemplated that other embodiments may have a single lens hole that can capture both photo and video elements. The separation of these lens holes could be intended to optimize the quality of captured images and videos, ensuring that both types of media are recorded simultaneously. The first photo lens hole 1020 might focus on taking high-resolution still images, while the second video lens hole 1030 may capture continuous motion during gameplay. These two processes could then be managed separately for different types of post-game distribution and sharing.

The media captured by the cameras may be processed and shared in various ways. Still images, for example, could be uploaded to a cloud-based service, allowing players to view or share their photos on social media platforms. Meanwhile, video footage, including slow-motion clips, could be played on external displays for the audience to view in real time. Players might also receive personalized links to access their videos and photos after the game, potentially delivered via email or a specialized app, depending on the onboarding process.

Although a specific embodiment for a photobooth camera and safety enclosure suitable for carrying out the various steps, processes, methods, and operations described herein is discussed with respect to FIG. 10, any of a variety of systems and/or processes may be utilized in accordance with embodiments of the disclosure. For example, the cameras 1000 can be disposed within a safety enclosure 1010 which can be configured with one or more holes 1020 that are often configured to match the diameter or shape of a lens of a camera 1000. The elements depicted in FIG. 10 may also be interchangeable with other elements of FIGS. 1-9 and 11 as required to realize a particularly desired embodiment.

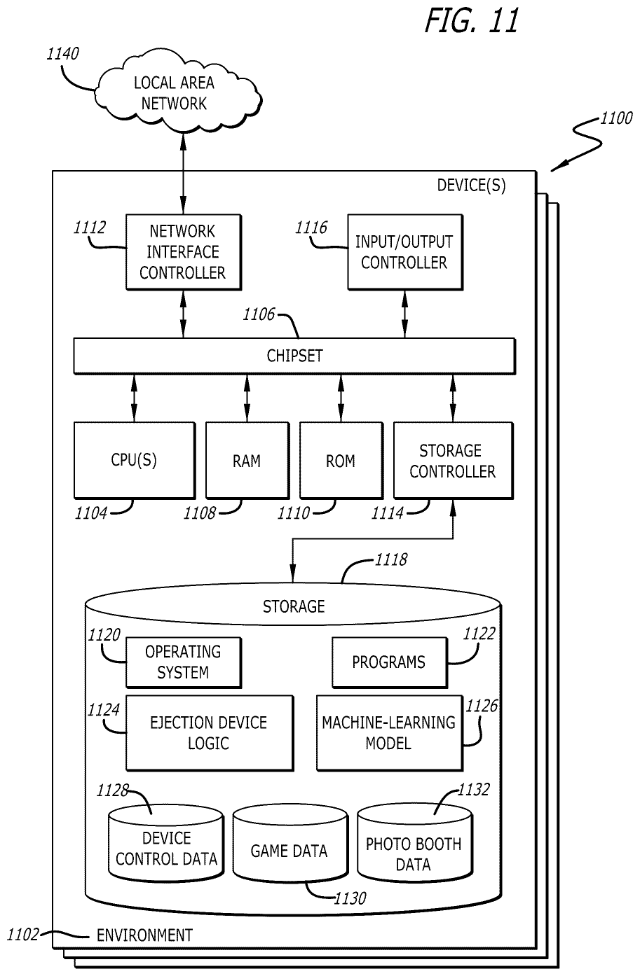

Referring to FIG. 11, a conceptual illustration of a device suitable for operating and executing a multi-purpose game logic in accordance with various embodiments of the disclosure is shown. The embodiment of the conceptual block diagram depicted in FIG. 11 can illustrate a conventional server computer, workstation, desktop computer, laptop, tablet, network appliance, e-reader, smartphone, or other computing device, and can be utilized to execute any of the application and/or logic components presented herein. The device 1100 may, in some examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. In some embodiments, the device 1100 may be considered a controller or configured as a static controller deployed in proprietary hardware layouts. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In additional embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Different embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for example, store an operating system 1120, applications 1122, and data 1128, 1130, 1132, which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

For example, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In various embodiment, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described herein with regard to FIGS. 1-8 and 10-12. In more embodiments, the device 1100 can also include computer-readable storage media having instructions stored thereupon for performing any of the other computer-implemented operations described herein.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11, and can include other components that are not explicitly shown in FIG. 11, or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In many embodiments, the device 1100 can include an ejection device logic 1124 that can be configured to perform one or more of the various steps, processes, operations, and/or other methods that are described above. Often, the ejection device logic 1124 can be a set of instructions stored within a non-volatile memory that, when executed by the processor(s)/controller(s) 1104 can carry out these steps, etc. In some embodiments, the ejection device logic 1124 may be a client application that resides on a network-connected device, such as, but not limited to, a server, switch, personal or mobile computing device. In certain embodiments, the ejection device logic 1124 can direct the processing and ejection of materials within a bomb room or other multi-purpose interactive game room.

However, in additional embodiments, the ejection device logic 1124 may act as the central control for managing the entire interactive game experience, coordinating the release of ejection materials, integrating player interactions, and synchronizing with multimedia elements like photos and videos. In certain embodiments, this logic can interface with device control data 1128, ensuring components like air compressors, pumps, and ejection tubes are ready for operation, while also managing safety protocols, possibly using machine-learning to enhance accuracy. It may also integrate with game data 1130 to trigger specific events based on real-time gameplay, such as releasing ejection materials after player milestones. Additionally, the logic can, in some embodiments, work with photobooth data 1132 to capture key moments, like the release of foam or paint, by triggering camera systems to record these events, which can then be replayed on displays or shared with players post-game. This integration can create a seamless, immersive experience that combines physical actions with digital rewards.

In various embodiments, the storage 1118 can include device control data 1128. Device control data 1128 may play a role in managing the operational aspects of the auto-refillable ejection system, ensuring the system functions smoothly and safely. This data can encompass various parameters, such as pressure levels in the ejection tubes, valve statuses, and refill rates for the canisters containing ejection materials. By constantly monitoring and adjusting these parameters, the device control data 1128 may ensure that the ejection devices are always primed and ready to perform, maintaining the necessary pressure and material levels for a seamless gaming experience. In certain embodiments, the device control data 1128 may also regulate specific actions of the system, such as triggering solenoids to release compressed air or opening valves to direct ejection material into the tubes. Additionally, it could be responsible for tracking the readiness status of the system, providing feedback via the control panel to signal whether the device is armed, refilling, or fully operational. Device control data 1128 may integrate with other game elements, such as photobooth data and game logic, to ensure all components are synchronized, allowing for precise timing of ejection events with game milestones or capturing key moments with high-lumen photography during gameplay. Overall, this data may act as the backbone of the system's functionality, keeping the ejection devices responsive and efficient.

In a number of embodiments, the storage 1118 can include game data 1130. Game data 1130 may serve as a component within the overall system, tracking player interactions, game states, and environmental factors to dynamically influence the gameplay experience. This data can include player-specific details such as names, team assignments, and historical performance, which may be used to personalize the game environment and tailor the experience to each player or team. The game data 1130 may also integrate sensor information from within the game room, such as player movements or interactions with physical game elements, which could be processed by the game logic to trigger in-game events like the release of ejection materials. Additionally, game data 1130 can encompass details about the current game state, such as scores, time remaining, or progress through specific game challenges. The game state may be configured to correspond with changes in both the game room, including lighting, flashes, blacklights, etc. and the control of the camera/photobooth. This information could be displayed to players in real-time through in-room monitors or external displays for spectators. By constantly updating and communicating with the ejection device logic and photobooth system, game data 1130 may enhance the responsiveness and interactivity of the overall experience, ensuring that each action within the game has a tangible, immediate impact.

In still more embodiments, the storage 1118 can include photo booth data 1132. Photo booth data 1132 may be a component in enhancing the immersive and interactive nature of the gaming experience, particularly in systems where auto-refillable ejection devices are used. This data could encompass various forms of media, including still images, video recordings, and even slow-motion footage, all captured in real-time as players engage in the interactive game. The photobooth system may work in tandem with the ejection device logic, ensuring that critical moments, such as the instant when players are covered in ejection material, are captured from multiple angles. The photobooth data 1132 may include metadata related to the game session, such as player names, game scores, and timestamps, allowing for customized or personalized media outputs. Once captured, the data can be processed and shared across multiple platforms, with still images sent to cloud storage or social media for sharing, and video clips possibly prepared for slow-motion replays that could be displayed on nearby monitors. The integration of photo booth data 1132 with device control data 1128 and game data 1130 may allow for seamless synchronization, ensuring the capture of key moments without manual intervention. Furthermore, this data can be packaged and distributed to players via personalized links or email, offering them a keepsake of their experience. In this way, photo booth data 1132 may elevate the overall gaming experience by providing an interactive, memorable, and shareable component that enhances both the gameplay and its aftermath.

Finally, in many embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126. The ML model 1126 may be configured to process sensor data 1130 and/or execute a selected game within the multi-purpose interactive game room.

The ML model(s) 1126 can be configured to generate inferences to make predictions or draw conclusions from data. An inference can be considered the output of a process of applying a model to new data. This can occur by learning from game data, previously generated data, and/or score data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes.

Although a specific embodiment for a device suitable for operating and executing a multi-purpose game logic suitable for carrying out the various steps, processes, methods, and operations described herein is discussed with respect to FIG. 11, any of a variety of systems and/or processes may be utilized in accordance with embodiments of the disclosure. For example, the device may be a computing device located within the multi-purpose interactive game room, but may be located on a remote-based device. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An ejection device, comprising:
a plurality of ejection orifices;
at least one canister of ejection material connected to the plurality of orifices;
a series of pumps to:
generate pressure for ejection of the ejection material; and
provide for moving ejection material from the at least one canister to the plurality of orifices; and
a controller to coordinate the series of pumps and ejection of the ejection material.

2. The ejection device of claim 1, wherein the ejection orifices are associated with a series of ejection tubes.

3. The ejection device of claim 2, wherein the ejection tubes are disposed with an ejection orifice at a first end and a conduit connector on the second end.

4. The ejection device of claim 3, wherein the conduit is a flexible pipe.

5. The ejection device of claim 4, wherein the flexible pipe is configured to be disposed between the second end of the ejection tube and to one or more of the at least one canister.

6. The ejection device of claim 5, wherein the canisters are filled with a liquid ejection substance.

7. The ejection device of claim 6, wherein the liquid ejection substance is a paint-based substance.

8. The ejection device of claim 7, wherein the ejection device comprises two or more canisters.

9. The ejection device of claim 8, wherein each of the ejection tubes are associated with a single corresponding canister.

10. The ejection device of claim 9, wherein each of the corresponding canisters comprise a unique color of the paint-based substance.

11. The ejection device of claim 9, wherein each of the corresponding canisters is associated with two or more ejection tubes.

12. The ejection device of claim 6, wherein the liquid ejection substance is a foam-based substance.

13. The ejection device of claim 12, wherein the foam-based substance is a uniform color.

14. The ejection device of claim 12, wherein the foam-based substance comprises two or more colors.

15. The ejection device of claim 1, wherein the pressure generated for the ejection material is controlled by the controller.

16. The ejection device of claim 15, wherein the controller is in communication with a game logic.

17. The ejection device of claim 16, wherein the pressure is generated based on at least one current game state associated with the game logic.

18. The ejection device of claim 16, wherein ejection of the ejection material is based on a current game state associated with the game logic.

19. The ejection device of claim 18, wherein the current game state is associated with a game ending.

20. A game room, comprising:
an ejection device comprising:
a plurality of ejection orifices;
at least one canister of ejection material connected to the plurality of orifices;
a series of pumps to:
generate pressure for ejection of the ejection material; and
provide for moving ejection material from the at least one canister to the plurality of orifices; and
a controller to coordinate the series of pumps and ejection of the ejection material; and
a photobooth device, comprising:
a camera,
a communication interface commutatively coupled with the camera; and
a safety enclosure configured to shield the camera from the surrounding environment.
